(19) United States
(12) Patent Application Publication
(10) Pub. No.: US 2026/0093418 A1
(43) Pub. Date: Apr. 2, 2026

(54) STORAGE DEVICE, STORAGE SYSTEM, AND OPERATION METHOD OF STORAGE SYSTEM

(71) Applicant: Samsung Electronics Co., Ltd., Suwon-si (KR)

(72) Inventors: Minsoo Song, Suwon-si (KR); Sungwook Kim, Suwon-si (KR); Byungyo Lee, Suwon-si (KR)

(21) Appl. No.: 19/263,299

(22) Filed: Jul. 8, 2025

(30) Foreign Application Priority Data
Oct. 2, 2024 (KR) 10-2024-0134220

(51) Int. Cl. G06F 3/06

(52) U.S. Cl. CPC G06F 3/0659; G06F 3/0613; G06F 3/0679

(57) ABSTRACT

A storage device includes a non-volatile memory device including a first area and a second area, and a storage controller configured to communicate with an external host device based on a non-volatile memory express protocol. The storage controller is configured to receive a write command including a directive value from the external host device, receive data corresponding to the write command, and in response to an adaptive data placement feature that is enabled store the data in one area of the first area or the second area that corresponds to the directive value. The first area includes memory cells configured to store n-bits per cell, and the second area includes memory cells configured to store m-bits per cell, where n is a positive integer, m is a positive integer greater than n.

### CROSS-REFERENCE TO RELATED APPLICATION(S)

This application is based on and claims priority under 35 U.S.C. § 119 to Korean Patent Application No. 10-2024-0134220, filed on Oct. 2, 2024, in the Korean Intellectual Property Office, the disclosure of which is incorporated by reference herein in its entirety.

### BACKGROUND

Semiconductor memories can be classified into volatile memory devices such as static random access memory (SRAM) and dynamic random access memory (DRAM), in which stored data is erased when power supply thereto is cut off, and non-volatile memory devices such as flash memory devices, phase-change random access memory (PRAM), magnetic random access memory (MRAM), resistive random access memory (RRAM), and ferroelectrics random access memory (FRAM), in which stored data is maintained even when power supply thereto is cut off.

As demand for high-capacity data storage devices has rapidly increased, interest in quad-level cell (QLC) solid state drive (SSD) has increased. QLC SSD can store 4 bits of data per cell, providing higher storage density than triple-level cell (TLC) SSD. QLC SSD shows relatively lower performance than TLC SSD in terms of write endurance and reliability. In particular, the higher the number of data writes and deletes, the shorter the lifetime, requiring additional technical improvements to improve reliability.

### SUMMARY

The present disclosure provides a storage device and a storage system which have improved performance, and a method of operating the storage system.

According to an aspect of the present disclosure, there is provided a storage device including a non-volatile memory device that includes a first area and a second area, and a storage controller communicating with an external host device, based on a non-volatile memory express protocol, receiving a write command including a directive value from the external host device, receiving data corresponding to the write command, and in response to an adaptive data placement feature that is enabled, storing the data in one area, which corresponds to the directive value, of the first area and the second area, wherein the first area includes memory cells configured to store n-bits per cell (wherein n is a positive integer), and the second area includes memory cells configured to store m-bits per cell (wherein m is a positive integer greater than n).

According to another aspect of the present disclosure, there is provided a method of operating a storage system including a host device and a storage device, the method including transmitting, by the host device, a write command that includes a directive value to the storage device, receiving, by the storage device, data corresponding to the write command, in response to the write command, and storing, by the storage device, the data in one area which corresponds to the directive value, of a first area and a second area, in response to an adaptive data placement feature that is enabled, wherein the storage device includes a non-volatile memory device that includes the first area and the second area, and the first area includes memory cells configured to store n-bits per cell (wherein n is a positive integer), and the second area includes memory cells configured to store m-bits per cell (wherein m is a positive integer greater than n).

According to another aspect of the present disclosure, there is provided a storage system including a storage device that includes a first area and a second area, and a host device configured to control the storage device, wherein the host device enables an adaptive data placement feature of the storage device and transmits a write command to the storage device, in which the write command includes a directive value that indicates type information about an area where data is to be stored, when the adaptive data placement feature is enabled, the storage device stores the data in one area which corresponds to the directive value, of the first area and the second area, in response to the write command, and the first area includes memory cells configured to store n-bits per cell (wherein n is a positive integer), and the second area includes memory cells configured to store m-bits per cell (wherein m is a positive integer greater than n).

### BRIEF DESCRIPTION OF THE DRAWINGS

Implementations will be more clearly understood from the following detailed description taken in conjunction with the accompanying drawings in which:

FIG. 1 is a block diagram showing a storage system according to an implementation;

FIGS. 2A to 2C are diagrams for explaining an operation of the storage system of FIG. 1;

FIG. 3 is a diagram showing an example of a write command according to an implementation;

FIG. 4 is a diagram showing storage spaces of the storage device of FIG. 1;

FIG. 5 is a diagram for explaining an operation of the storage device of FIG. 1;

FIG. 6 is a flowchart showing an example of an operation method of the storage device of FIG. 1;

FIG. 7 is a flowchart showing an example of an operation method of the storage system of FIG. 1;

FIG. 8 is a flowchart showing operation S310 of FIG. 7 in more detail;

FIG. 9 is a flowchart showing operation S320 of FIG. 7 in more detail;

FIG. 10 is a flowchart showing operation S330 of FIG. 7 in more detail;

FIG. 11 is a flowchart showing operation S340 of FIG. 7 in more detail;

FIG. 12 is a flowchart showing operation S350 of FIG. 7 in more detail;

FIG. 13 is a flowchart showing operation S360 of FIG. 7 in more detail; and

FIG. 14 is a diagram illustrating a system according to some implementations.

### DETAILED DESCRIPTION

Hereinafter, implementations will be described clearly and in detail to such an extent that one of ordinary skill in the art may easily practice the present disclosure.

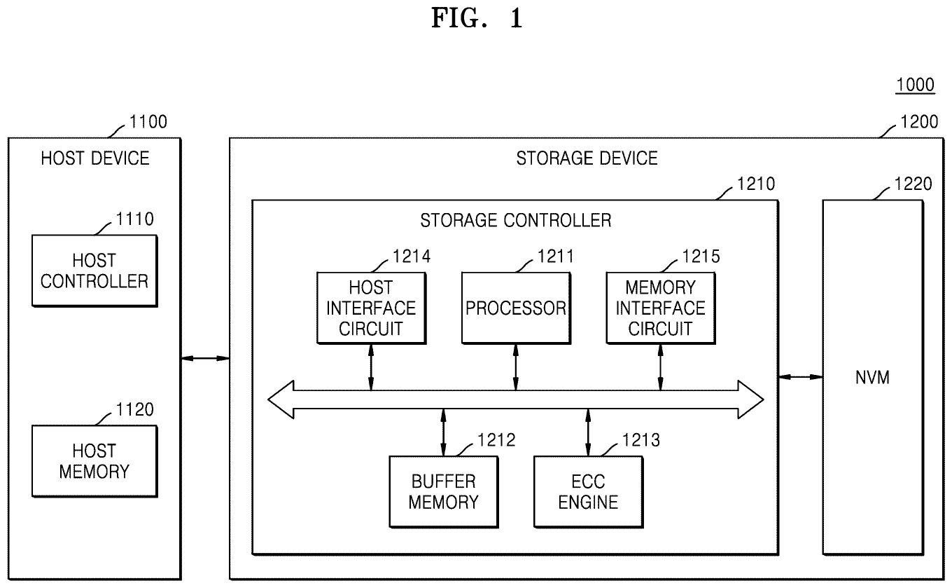

FIG. 1 is a block diagram showing a storage system according to some implementations.

Referring to FIG. 1, a storage system 1000 may include a host device 1100 and a storage device 1200. In an implementation, the storage device 1200 may include a mass storage medium such as a solid state drive (SSD). The storage device 1200 may be included in one of information processing devices configured to process various information and store processed information, such as a personal computer (PC), a laptop, a server, a workstation, a smartphone, a tablet PC, a digital camera, a black box, and the like. However, the scope of the present disclosure is not limited thereto, and the storage device 1200 may be implemented in various forms and may be included in other devices or other systems.

In an implementation, the host device 1100 may include a host controller 1110 and a host memory 1120. The host memory 1120 may function as a buffer memory for temporarily storing data to be transmitted to the storage device 1200 or data transmitted from the storage device 1200.

According to an implementation, the host controller 1110 and the host memory 1120 may be implemented as separate semiconductor chips. Alternatively, in some implementations, the host controller 1110 and the host memory 1120 may be integrated into the same semiconductor chip. As an example, the host controller 1110 may be included in one of a plurality of modules provided in an application processor, and the application processor may be implemented as a system on chip (SoC). Additionally, the host memory 1120 may include an embedded memory provided within the application processor, or may include a non-volatile memory or a memory module located outside the application processor.

The host controller 1110 may manage operations of storing, in a non-volatile memory device 1220, data (e.g., write data) of a buffer area of the host memory 1120 non-volatile, or storing, in the buffer area, data (e.g., read data) of the non-volatile memory device 1220.

The host device 1100 may be configured to control the storage device 1200. For example, the host device 1100 may store data in the storage device 1200 or read data stored in the storage device 1200, based on a predefined interface. In an implementation, the predefined interface may include a non-volatile memory express (NVMe) interface. However, the scope of the present disclosure is not limited thereto, and the predefined interface may include at least one of various interfaces such as advanced technology attachment (ATA), serial ATA (SATA), external SATA (e-SATA), small computer small interface (SCSI), serial attached SCSI (SAS), peripheral component interconnection (PCI), PCI express (PCIe), universal flash storage (UFS), IEEE 1394, universal serial bus (USB), secure digital (SD) card, multi-media card (MMC), embedded MMC (eMMC), universal flash storage (UFS), embedded (eUFS), compact flash (CF) card, compute eXpress link (CXL) interface, etc. The storage device 1200 may include a storage controller 1210 and the non-volatile memory device 1220. In an implementation, the storage device 1200 may include an NVMe device that complies with the NVMe standard.

The storage controller 1210 may operate under the control by the host device 1100. For example, the storage controller 1210 may store data in the non-volatile memory device 1220 or provide data stored in the non-volatile memory device 1220 to the host device 1100 under the control by the host device 1100. In an implementation, the storage controller 1210 may perform various management operations under the control by the host device 1100. In an implementation, the various management operations may include operations of setting a variety of information of the storage device 1200 or providing the variety of information set in the storage device 1200 to the host device 1100.

The storage controller 1210 may include a processor 1211, a buffer memory 1212, an error correction code (ECC) engine 1213, a host interface circuit 1214, and a memory interface circuit 1215.

The processor 1211 may control all operations of the storage controller 1210. For example, the processor 1211 may drive an operating system or firmware for driving the storage controller 1210. The processor 1211 may generate commands and addresses for controlling the non-volatile memory device 1220, based on requests from the host device 1100.

The buffer memory 1212 may temporarily store data to be stored in the non-volatile memory device 1220 or data read from the non-volatile memory device 1220. The buffer memory 1212 may be configured to store a variety of information required for the storage controller 1210 to operate. For example, the buffer memory 1212 may be configured to store a map table for accessing the non-volatile memory device 1220. In an implementation, the buffer memory 1212 may include random access memory. For example, the buffer memory 1212 may include SRAM or DRAM.

The ECC engine 1213 may perform ECC encoding on user data to be stored in the non-volatile memory device 1220 to generate parity data. The generated parity data may be stored in the non-volatile memory device 1220 together with user data. The ECC engine 1213 may be configured to perform ECC decoding based on user data and parity data read from the non-volatile memory device 1220 to correct errors in user data.

The host interface circuit 1214 may be configured to communicate with the host device 1100. In an implementation, the host interface circuit 1214 may be configured to comply with a predefined interface, communication protocol, or communication standard between the host device 1100 and the storage device 1200. In an implementation, the host interface circuit 1214 may be configured to comply with the NVMe standard.

The memory interface circuit 1215 may be configured to access the non-volatile memory device 1220. For example, the memory interface circuit 1215 may be configured to access the non-volatile memory device 1220 based on commands and addresses generated by the processor 1211 to control the non-volatile memory device 1220. In an implementation, the memory interface circuit 1215 may communicate with the non-volatile memory device 1220, based on a standard-based or manufacturer-defined interface or protocol. In an implementation, the manufacturer-defined interface or protocol described above may include a toggle interface or an open NAND flash interface (ONFI).

The non-volatile memory device 1220 may operate under the control by the storage controller 1210. The non-volatile memory device 1220 may include a plurality of non-volatile memories. In an implementation, the plurality of non-volatile memories included in the non-volatile memory device 1220 may communicate with the storage controller 1210 through a plurality of channels and form a plurality of ways. In an implementation, the non-volatile memory device 1220 may be configured based on NAND flash memory. However, the scope of the present disclosure is not limited thereto, and the non-volatile memory device 1220 may be based on at least one of various non-volatile memory devices such as a phase change memory device, a ferroelectric memory device, a magnetic memory device, a resistive memory device, and the like.

The non-volatile memory device 1220 may include multiple types of memories. For example, the types of memory included in the non-volatile memory device 1220 may include a first type T1 and a second type T2. For example, the first type T1 may include a triple level cell (TLC), and the second type T2 may include a quad level cell (QLC). However, the scope of the present disclosure is not limited thereto, and the number of types of memory included in the non-volatile memory device 1220 may increase or decrease depending on the implementation thereof.

In an implementation, the storage system 1000 may be configured to support or manage an adaptive data placement (ADP) feature for the non-volatile memory device 1220. The adaptive data placement feature may refer to an operation of storing data in an area (or a type of memory) determined by the host device 1100. For example, the storage system 1000 may enable or disable the adaptive data placement feature. When the adaptive data placement feature is enabled, the storage system 1000 may perform an adaptive data placement operation.

In an implementation, the host device 1100 may enable or disable the adaptive data placement feature of the storage device 1200. The host device 1100 may enable the adaptive data placement feature of the storage device 1200, and then the host device 1100 may determine, through type information, an area of the storage device 1200 where data is to be stored. The host device 1100 may transmit a command including the type information to the storage device 1200. The type information may indicate a type of the area in which data is to be stored in the storage device 1200. For example, the type information may indicate any one of the first type T1 and the second type T2.

In an implementation, the host device 1100 may store data in a TLC memory (e.g., a TLC area) in the QLC SSD. The host device 1100 may choose to store data in the TLC memory. The host device 1100 may instruct or request the storage device 1200 to store data in the TLC memory. The host device 1100 may directly use the TLC memory of the storage device 1200. The host device 1100 may store data in the TLC memory or a QLC memory through the adaptive data placement feature.

The function of the storage device 1200 may include an adaptive data placement operation. The storage system 1000 may selectively store data where reliability is critical, in the TLC memory. The storage device 1200 may selectively store data in the TLC memory or the QLC memory through the adaptive data placement operation. The configuration and effects according to implementations will be described in more detail with reference to the drawings below.

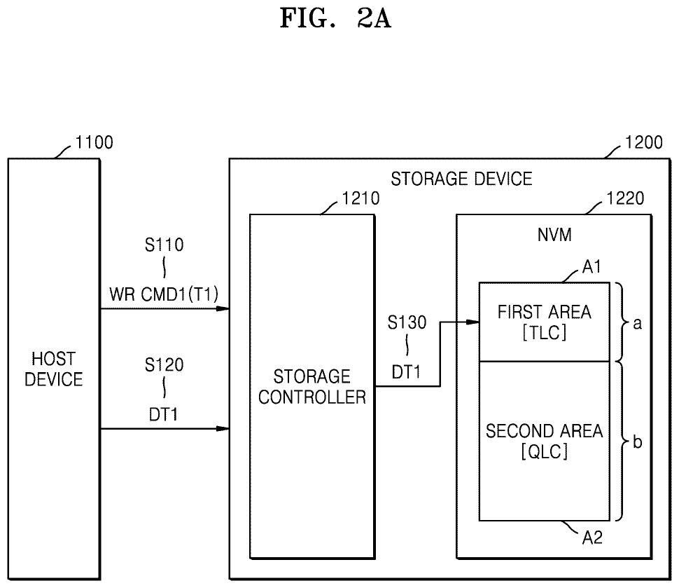

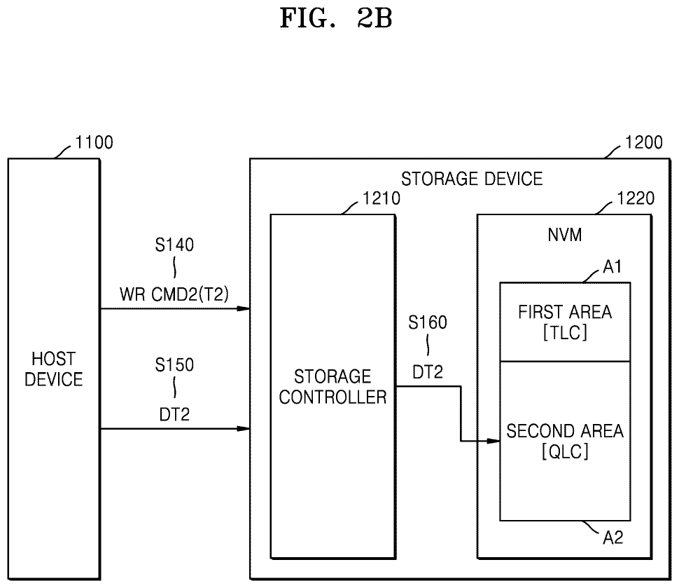

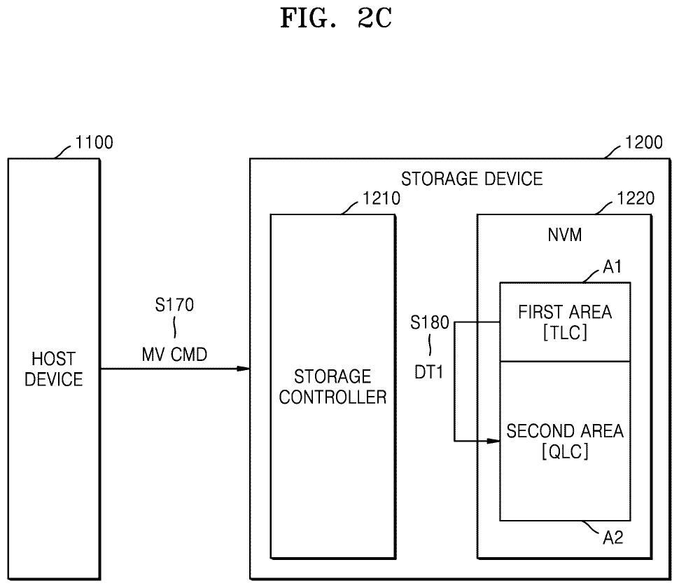

FIGS. 2A to 2C are diagrams for explaining the operation of the storage system 1000 of FIG. 1.

Referring to FIGS. 1, 2A, 2B, and 2C, the storage system 1000 may perform the adaptive data placement operation. The adaptive data placement operation may refer to an operation by which the host device 1100 places data in an appropriate memory type, or an appropriate memory area.

For example, the storage system 1000 may store normal data in a second area A2 (e.g., the QLC memory). The storage system 1000 may store data that require high reliability, in a first area A1 (e.g., the TLC memory). The storage system 1000 may store data (e.g., cold data) expected to have a long storage period in the first area A1 (e.g., the TLC memory).

In an implementation, storage spaces of the storage device 1200 may refer to physical areas in the non-volatile memory device 1220 where actual user data is stored. That is, the storage spaces of the storage device 1200 may be spaces that may be identified by the host device 1100 as the storage capacity of the storage device 1200.

In an implementation, the storage device 1200 may further include other storage spaces other than the storage spaces illustrated in FIG. 2A. For example, the other storage spaces may include various spaces that are not identified by the host device 1100 as the storage capacity of the storage device 1200, such as a spare area, a meta area for storing metadata, or an over-provisioning area for performance enhancement. Hereinafter, for convenience of explanation of the present disclosure, detailed descriptions thereof are omitted or briefly given, and implementations of the present disclosure are described focusing on storage spaces where user data is stored.

The storage spaces of the storage device 1200 may include the first area A1 and the second area A2. The first area A1 may correspond to a portion (e.g., “a”) of the storage spaces of the storage device 1200 (or the storage spaces of the non-volatile memory device 1220). The second area A2 may correspond to the remaining portion (e.g., “b”) of the storage spaces of the storage device 1200.

In an implementation, the first area A1 may correspond to the first type T1, and the second area A2 may correspond to the second type T2. The first area A1 may include memory cells of the first type T1, and the second area A2 may include memory cells of the second type T2. In an implementation, the first area A1 may be a secondary area and the second area A2 may be a primary area. The size of the first area A1 may be less than the size of the second area A2.

In an implementation, each of the memory cells corresponding to or included in the first area A1 may be used as TLC, and each of the memory cells corresponding to or included in the second area A2 may be used as QLC. Alternatively, each of the memory cells corresponding to the first area A1 may be configured to store n-bit data (wherein n is a positive integer), and each of the memory cells corresponding to the second area A2 may be configured to store m-bit data (wherein m is a positive integer greater than n). That is, the first area A1 may indicate an area that supports faster high-speed writes than the second area A2. The first area A1 may indicate an area that is more reliable than the second area A2.

In an implementation, the number of bits stored in each memory cell of the first area A1 and the second area A2 may be determined by various factors such as reliability and lifespan of the storage device 1200. Alternatively, the first area A1 may be distinguished from the second area A2 by various factors other than the number of bits per cell, such as reliability and lifespan.

In an implementation, reference symbols “a” and “b” may denote the number of memory blocks of the non-volatile memory device 1220 corresponding to each storage space. Depending on the size and implementation (e.g., SLC, MLC, TLC, QLC, OLC, etc.) of each of the first area A1 and the second area A2, values of “a” and “b” may vary.

In an implementation, the storage device 1200 may support the adaptive data placement feature, as described with reference to FIG. 1. When the adaptive data placement feature is enabled by the host device 1100, the storage device 1200 may perform the adaptive data placement operation. The storage device 1200 may store data in any one of the first area A1 and the second area A2. When the adaptive data placement feature is disabled by the host device 1100, the storage device 1200 may store data in the second area A2.

Hereinafter, it is assumed that the adaptive data placement feature is enabled by the host device 1100. For example, in operation S110, the host device 1100 may transmit a first write command including the first type T1 to the storage device 1200. In operation S120, the storage device 1200 may receive first data DT1 corresponding to the first write command. In operation S130, since the adaptive data placement feature is enabled, the storage device 1200 may determine the type of memory in which the first data DT1 is to be stored. The storage controller 1210 may identify the first type T1 included in the first write command. The storage controller 1210 may determine to store the first data DT1 in the first area A1 (e.g., the TLC area), based on the first type T1. The storage controller 1210 may write the first data DT1 to the first area A1. Afterwards, the storage device 1200 may transmit a response (e.g., a completion entry) to the host device 1100.

In operation S140, the host device 1100 may transmit a second write command including the second type T2 to the storage device 1200. In operation S150, the storage device 1200 may receive second data DT2 corresponding to the second write command. In operation S160, since the adaptive data placement feature is enabled, the storage device 1200 may determine the type of memory in which the second data DT2 is to be stored. The storage controller 1210 may identify the second type T2 included in the second write command. The storage controller 1210 may determine to store the second data DT2 in the second area A2 (e.g., a QLC area), based on the second type T2. The storage controller 1210 may write the second data DT2 to the second area A2. Afterwards, the storage device 1200 may transmit a response to the host device 1100.

In an implementation, the storage system 1000 may migrate, or move, data stored in the first area A1 to the second area A2. In an implementation, data stored in the first area A1 may continue to be stored (or maintained) in the first area A1 without moving. In an implementation, data stored in the first area A1 may be moved to the second area A2 under the control by the host device 1100.

In operation S170, the host device 1100 may transmit a move command to the storage device 1200. In operation S180, the storage device 1200 may flush, migrate, or move data stored in the first area A1 to the second area A2, in response to the move command. The storage controller 1210 may read data stored in the first area A1. The storage controller 1210 may write the read first data DT1 to the second area A2.

As described above, the storage system 1000 may include the storage device 1200 including the first area A1 and the second area A2, and the host device 1100 configured to control the storage device 1200. The host device 1100 may enable the adaptive data placement feature of the storage device 1200 and transmit the write command to the storage device 1200, in which the write command may include type information (e.g., a directive value) that indicates the type information for an area where data will be stored. When the adaptive data placement feature is enabled, the storage device 1200 may store data in one area which corresponds to the type information of the first area A1 and the second area A2, in response to the write command. Accordingly, a storage device with improved performance may be provided by using the TLC memory, which has greater performance than the QLC memory. Additionally, a storage device with improved reliability may be provided.

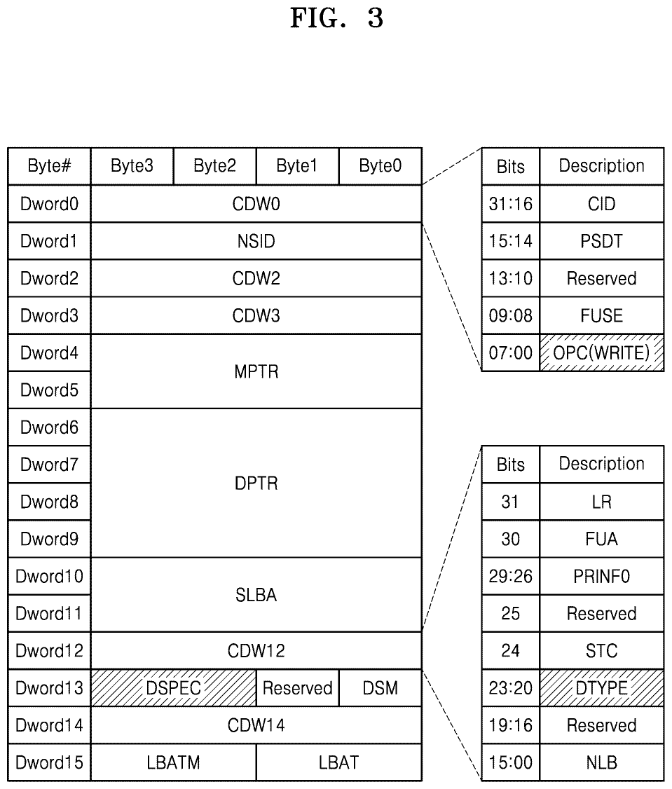

FIG. 3 is a diagram showing an example of a write command according to an implementation.

Referring to FIGS. 1 and 3, the storage system 1000 may determine the type of memory in which data is to be stored, based on a directive value DSPEC included in the write command. The host device 1100 may determine the type of memory in which data is to be stored. The storage device 1200 may store data in the type of memory determined by the host device 1100. Based on the directive value DSPEC, the storage device 1200 may determine an area in which data is to be written.

A format of the write command will be explained using NVMe, which is a register-level interface, as an example. However, it will be well understood that this example is only for the convenience of explanation. In an NVMe protocol, commands (or requests) may be arranged in 32-bit (Dword) units by default. The write command may include first to sixteenth double words Dword0 to Dword15. The first double word Dword0 may include various elements including command ID (CID), physical region pages (PRP) or scatter gather lists (SGL) for data transfer (PSDT), fused operation (FUSE), and opcode (OPC). For example, “CID” may represent a command identifier, “PSDT” may represent data transfer information, “FUSE” may represent whether to execute a command set in atomic units, and “OPC” may represent a code value (i.e., operation code) that specifies dynamic properties for the command. For example, the OPC of the write command may be “01b” and the OPC of a read request may be “10b”.

The second double word Dword1 may include a “namespace ID (NSID)”, where the “NSID” may represent an identifier of the namespace. The fifth and sixth double words Dword4 and Dword5 may include a “metadata pointer (MPTR)”, and the “MPTR” may represent information about the address of metadata. The seventh through tenth double words Dword6 through Dword9 may include a “data pointer (DPTR)”, and the “DPTR” may represent information about the address of data. The eleventh and twelfth double words Dword10 and Dword11 may include a “starting LBA (SLBA)”, and the “SLBA” may represent a starting logical address.

The thirteenth double word Dword12 may include various elements, such as limited retry (LR), force unit access (FUA), protection information field (PRINFO), storage tag check (STC), directive type (DTYPE), and number of logical blocks (NLB). The “LR” may represent information about error recovery attempts. The “FUA” may represent whether data is stored in the non-volatile memory device 1220 before transmitting the completion entry. The “PRINFO” may represent protection information. The “STC” may represent information about whether a storage tag has been checked. The “DTYPE” may represent information about directive type. The “NLB” may represent information about data size.

The fourteenth double word Dword13 may include “directive specific (DSPEC)” and “dataset management (DSM)”. The “DSPEC” may represent a specific value of a directive (i.e., a directive value) according to the directive type, and the “DSM” may represent properties of data.

The sixteenth double word Dword15 may include a “logical block application tag mask (LBATM)” and a “logical block application tag (LBAT)”. The “LBATM” may represent information about an application tag mask value, and the “LBAT” may represent information about an application tag value.

In the NVMe protocol, the host device 1100 may exchange information with the storage device 1200 through a directive mechanism. The host device 1100 may receive data related to the directive type from the storage device 1200 through a directive receive command. The host device 1100 may transmit data related to the directive type to the storage device 1200 through a directive send command.

The directive type may include identification, stream, data placement, etc. For example, a value of the directive type for the identification may be “00h”, the value of the directive type for the stream may be “01h”, and the value of the directive type for the data placement may be “02h”. In an implementation, the directive type may further include a memory type. For example, the value of the directive type for the memory type may be “03h”.

In an implementation, the host device 1100 may use the memory type among the directive types when performing the adaptive data placement operation. In the following, it is assumed that the memory type is used as the directive type in the adaptive data placement operation. However, the scope of the present disclosure is not limited thereto.

In an implementation, the directive value DSPEC may include type information. The directive value DSPEC may indicate the type information. For example, the type information may indicate information about the type of memory in which the corresponding data is to be stored. The type information may indicate any one of the first type T1 and the second type T2.

In an implementation, the directive value DSPEC may include the type information and data group information. For example, the data group information may indicate information about a data group in which data is to be stored. The non-volatile memory device 1220 may include a plurality of data groups, and each of the plurality of data groups may include a plurality of data units. For example, the data group may correspond to a memory die or a memory chip.

In some implementations, the host device 1100 according to some implementations of the present disclosure may transmit the write command including the type information to the storage device 1200. The host device 1100 may transmit the type information or the data group information through the directive type DTYPE and the directive value DSPEC. For example, the host device 1100 may set the directive type DTYPE to the memory type (e.g., “03h”) and set the directive value DSPEC to the type information in the write command. Alternatively, the host device 1100 may set the directive type DTYPE to the memory type (e.g., “03h”) and set the directive value DSPEC to the type information and the data group information in the write command. The storage device 1200 may determine the type information or the data group information based on the directive type DTYPE and the directive value DSPEC in the write command.

As described above, the storage device 1200 may include the non-volatile memory device 1220 including the first area A1 and the second area A2, and the storage controller 1210 that communicates with the host device 1100 based on the NVMe protocol, receives the write command including the directive value from the host device 1100, receives data corresponding to the write command, and stores data in an area which corresponds to the directive value DSPEC, of the first area A1 and the second area A2, in response to the adaptive data placement feature that is enabled. Accordingly, the storage device 1200 with improved reliability may be provided.

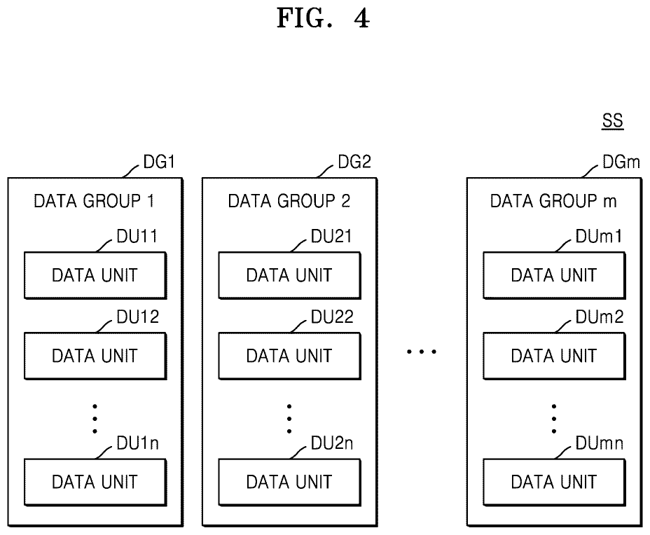

FIG. 4 is a diagram showing storage spaces of the storage device 1200 of FIG. 1.

Referring to FIGS. 1 and 4, a storage space SS of the storage device 1200 may include a plurality of data groups (DG), for example, DG1 to DGm. For example, a data group may correspond to each of a plurality of non-volatile memories (or memory dies). Each of the plurality of data groups DG1 to DGm may include a plurality of data units (DU). For example, a first data group DG1 may include data units DU11 to DU1n, and a second data group DG2 may include data units DU21 to DU2n. The remaining data groups DG3 to DGm may be identical or similar to the first or second group DG1 or DG2, so detailed descriptions thereof will be omitted.

For example, the data unit may correspond to a memory block. Alternatively, the data unit may include at least one memory block, sub-block, or super-block. The sub-block may be a portion of the memory block. The super-block may include at least two memory blocks.

In an implementation, some of the data units included in the data group may be included in the first area A1, and some of the remaining data units included in the data group may be included in the second area A2. For example, in the first data group DG1, a data unit DU11 may correspond to the first type T1, and a data unit DU12 may correspond to the second type T2. That is, the data unit DU11 may be included in the first area A1, and the data unit DU12 may be included in the second area A2.

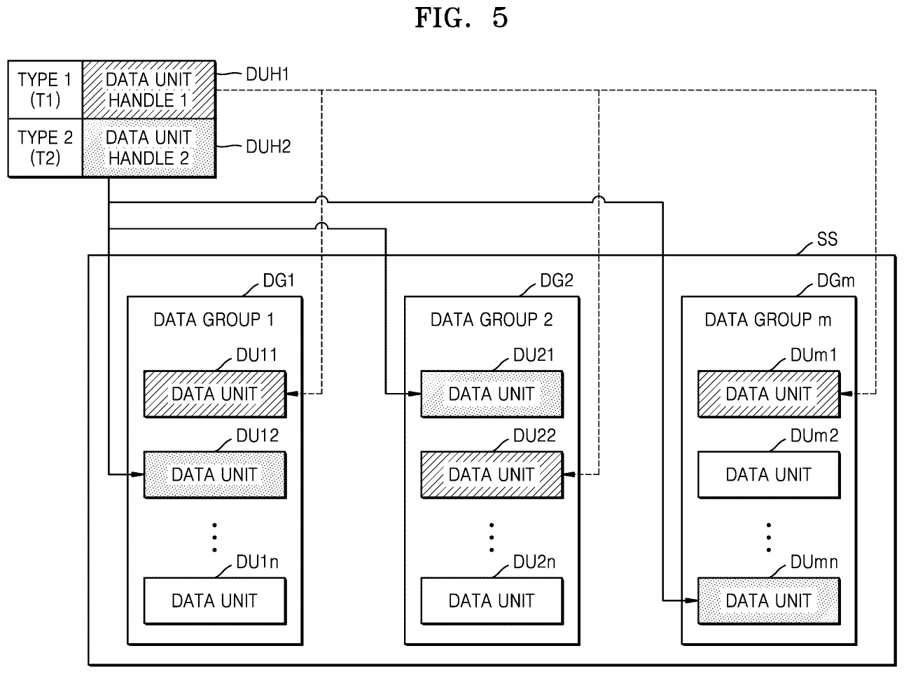

FIG. 5 is a diagram for explaining an operation of the storage device 1200 of FIG. 1.

Referring to FIGS. 1, 4, and 5, the storage system 1000 may set a configuration for the adaptive data placement feature. In an implementation, the storage system 1000 may set memory types and data unit handles when creating the namespace. The storage system 1000 may set parameter values for the adaptive data placement.

In an implementation, the storage device 1200 may map the memory type to data unit handles. For example, the first type T1 may be mapped to a first data unit handle DUH1, and the second type T2 may be mapped to a second data unit handle DUH2. However, the scope of the present disclosure is not limited thereto, and the number of memory types and the number of data unit handles may increase or decrease depending on the implementation thereof.

For example, the first type T1 may correspond to the first data unit handle DUH1. The second type T2 may correspond to the second data unit handle DUH2. The first data unit handle DUH1 may refer to data unit DU11 in the first data group DG1, data unit DU22 in the second data group DG2, and a data unit DUm1 in the m-th data group DGm. The second data unit handle DUH2 may refer to data unit DU12 in the first data group DG1, data unit DU21 in the second data group DG2, and a data unit DUmn in the m-th data group DGm.

In an implementation, since the data units DU11, DU22, and DUm1 may correspond to the first type T1, the memory cells included in the data units DU11, DU22, and DUm1 may be used as a TLC cell. On the other hand, the data units DU12, DU21, and DUmn may correspond to the second type T2, so the memory cells included in the data units DU12, DU21, and DUmn may be used as a QLC cell.

In an implementation, the non-volatile memory device 1220 may perform a first program operation on the data units DU11, DU22, and DUm1 to write data. The non-volatile memory device 1220 may perform a second program operation on the data units DU12, DU21, and DUmn to write data. The first program operation may refer to a TLC program operation, and the second program operation may refer to a QLC program operation.

The storage device 1200 may specify the data unit DU to store data therein, using the data unit handle DUH. The data unit handle DUH may refer to one data unit DU in each data group DG. When the data unit is fully written with data, the storage device 1200 may update the data unit handle by referring to another data unit in the same data group.

For example, the storage device 1200 may receive the first write command including the first type T1 and the directive value DSPEC that indicates the first data group DG1. The storage device 1200 may receive the first data corresponding to the first write command. The storage device 1200 may determine the data unit based on the directive value DSPEC. For example, the directive value DSPEC included in the first write command may indicate the first type T1, so the storage device 1200 may select the first data unit handle DUH1. That is, the storage device 1200 may determine the first data unit handle DUH1 corresponding to the first type T1 as the data unit handle for the first data DT1.

The directive value DSPEC may indicate the first data group DG1, so the storage device 1200 may determine the data unit that stores the first data DT1 in the first data group DG1. The storage device 1200 may determine the data unit that stores the first data DT1, based on the first data group DG1 and the first data unit handle DUH1. The first data unit handle DUH1 in the first data group DG1 may refer to the data unit DU11, so the storage device 1200 may write the first data DT1 to the data unit DU11.

In an implementation, the storage device 1200 may update the data unit handle. For example, when there is no more space to write new data to the data unit DU11, the storage device 1200 may update the first data unit handle DUH1. That is, when the data unit DU11 is a memory block that includes only word lines connected to memory cells programmed, the storage device 1200 may update the first data unit handle DUH1. The storage device 1200 may select a data unit that includes only word lines connected to memory cells that are in an erased state, and refer to the first data unit handle DHU1. For example, the storage device 1200 may connect the data unit DU1n to the first data unit handle DHU1.

The storage device 1200 may receive a second write command including the first type T1 and the directive value DSPEC that indicates the first data group DG1. The storage device 1200 may receive the second data corresponding to the second write command. The directive value DSPEC included in the second write command may indicate the first type T1, so the storage device 1200 may select the first data unit handle DUH1. That is, the storage device 1200 may determine the first data unit handle DUH1 corresponding to the first type T1 as the data unit handle for the second data DT2.

The directive value DSPEC may indicate the first data group DG1, so the storage device 1200 may determine the data unit that stores the second data DT2 in the first data group DG1. The storage device 1200 may determine the data unit that stores the first data DT1 based on the first data group DG1 and the first data unit handle DUH1. The first data unit handle DUH1 in the first data group DG1 may refer to the data unit DU1n, so the storage device 1200 may write the first data DT1 to the data unit DU1n.

In FIG. 5, the first type T1 is illustrated as corresponding to the first data unit handle DUH1, and the second type T2 is illustrated as corresponding to the second data unit handle DUH2. However, the scope of the present disclosure is not limited thereto, and the number of memory types and the number of data unit handles may increase or decrease depending on the implementation thereof. Additionally, the correspondence between memory types and data unit handles may not be 1:1.

For example, the first type T1 may correspond to the first data unit handle DUH1, the second type T2 may correspond to the second data unit handle DUH2, and the second type T2 may correspond to a third data unit handle DUH3.

In an implementation, the storage device 1200 may move data stored in the first area A1 to the second area A2, in response to a move command. In an implementation, the storage device 1200 may move data via external copying. For example, the storage controller 1210 may send a read command to the non-volatile memory device 1220. The read command may include an address corresponding to data stored in the first area A1. The non-volatile memory device 1220 may read first data from a memory cell array, in response to the read command. The non-volatile memory device 1220 may transmit data to the storage controller 1210.

The storage controller 1210 may transmit the write command and second data to the non-volatile memory device 1220. The write command may include an address corresponding to the second data to be stored in the second area A2. The second data may include the first data read from the first area A1. The non-volatile memory device 1220 may receive the write command and the second data. The non-volatile memory device 1220 may store the second data in the second area A2 in response to the write command. As such, to move data, data stored in the first area A1 may be transmitted from the non-volatile memory device 1220 to the storage controller 1210, and data may be then transmitted from the storage controller 1210 to the non-volatile memory device 1220.

In an implementation, the storage device 1200 may move data via internal copying. That is, data may be moved through internal copying in the non-volatile memory device 1220 without being transmitted from the non-volatile memory device 1220 to the storage controller 1210, and without being transmitted back from the storage controller 1210 to the non-volatile memory device 1220.

For example, the first data group DG1 may include a plurality of data units DU11 to DU1n. The data unit DU11 may be included in the first area A1, and the data unit DU12 may be included in the second area A2. That is, the data unit DU11 may correspond to the first type T1, and the data unit DU22 may correspond to the second type T2. The first data unit handle DUH1 may refer to the data unit DU11, and the second data unit handle DUH2 may refer to the data unit DU12. The first data group DG1 may correspond to any one of a plurality of non-volatile memories included in the non-volatile memory device 1220.

The storage device 1200 may move data stored in the data unit DU11 to the data unit DU12. That is, the storage device 1200 may move data stored in the first area A1 to the second area A2, in response to the move command. The non-volatile memory corresponding to the first data group DG1 may not transmit data read from the data unit U11 to the storage controller 1210. That is, the non-volatile memory may read the first data DT1 from the data unit DU11. The non-volatile memory may temporarily store the first data DT1 read from the memory cell array in a page buffer. The non-volatile memory may write the first data DT1 to the data unit DU12. That is, the non-volatile memory may rewrite the first data DT1 temporarily stored in the page buffer into the memory cell array.

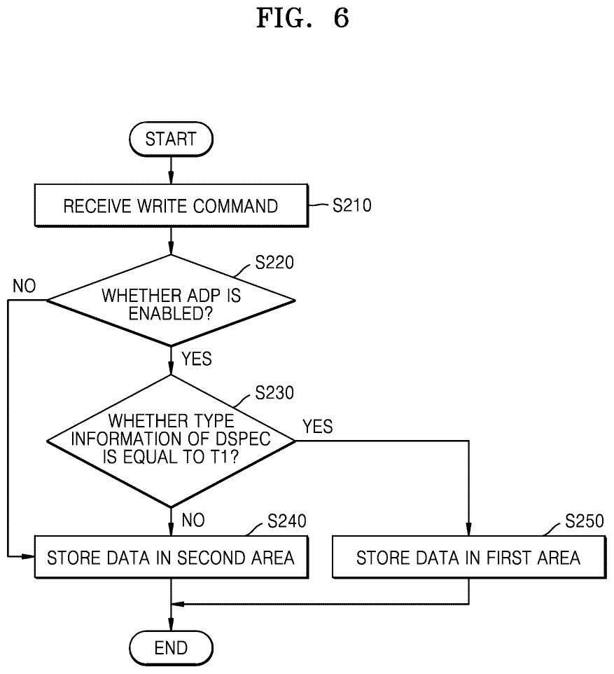

FIG. 6 is a flowchart showing an example of an operation method of the storage device 1200 of FIG. 1.

Referring to FIGS. 1, 5, and 6, the storage device 1200 may perform the adaptive data placement operation. In an implementation, the storage device 1200 may perform the adaptive data placement operation under the control by the host device 1100. At the request of the host device 1100, the storage device 1200 may enable the adaptive data placement feature.

In operation S210, the storage device 1200 may receive the write command from the host device 1100. For example, the write command may include the directive value DSPEC. The directive value DSPEC may include the type information or the data group information. The type information may refer to the memory type and may refer to any one the first type T1 and the second type T2. The storage device 1200 may receive data corresponding to the write command.

In operation S220, the storage device 1200 may determine whether the adaptive data placement feature is enabled. The storage device 1200 may determine whether the adaptive data placement operation is performed, in response to the write command. When the adaptive data placement feature is enabled, the storage device 1200 may perform an operation S230, and when the adaptive data placement feature is disabled, the storage device 1200 may perform the operation S240.

In an implementation, the storage device 1200 may perform the adaptive data placement operation when the adaptive data placement feature is enabled. The adaptive data placement operation may refer to an operation of writing write data to an area determined by the host device 1100. For example, the host device 1100 may determine to write data that requires reliability to the first area A1 (i.e., the TLC area). The host device 1100 may determine to write long-lived data to the first area A1. The host device 1100 may determine to write general data to the second area A2 (i.e., the QLC area). The storage device 1200 may write write data to any one of the first area A1 and the second area A2 at the request of the host device 1100. That is, the adaptive data placement operation may be an operation of writing write data to any one of the TLC area and the QLC area, depending on selection of the host device 1100.

The storage device 1200 may perform normal operation when the adaptive data placement feature is disabled. The normal operation may refer to an operation of writing data to the second area A2. That is, the normal operation may refer to an operation of storing write data in the QLC area.

In operation S230, the storage device 1200 may determine whether the type information of the directive value DSPEC indicates the first type T1. When the type information of the directive value DSPEC indicates the first type T1, the storage device 1200 may perform an operation S250, and when the type information of the directive value DSPEC does not indicate the first type T1, the storage device 1200 may perform the operation S240.

In an implementation, the storage device 1200 may determine an area in which data is to be stored based on the directive value DSPEC included in the write command. The storage device 1200 may store data in the first area A1 corresponding to the first type T1 when the type information in the directive value DSPEC indicates the first type T1. The storage device 1200 may store data in the second area A2 corresponding to the second type T2 when the type information in the directive value DSPEC indicates the second type T2.

The storage device 1200 may store data based on the directive value DSPEC when the adaptive data placement feature is enabled. The storage device 1200 may determine the data unit handle DUH corresponding to the memory type. The storage device 1200 may determine the data group and the data unit in which data is to be stored based on data group information of the determined data unit handle DUH and the directive value DSPEC.

In operation S240, the storage device 1200 may store data in the second area A2. For example, it is assumed that the date group information of the directive value DSPEC may include the first data group DG1 and the second data group DG2. The type information indicates the second type T2, so the storage device 1200 may determine, as the second data unit handle DUH2, the data unit handle DUH in which data is to be stored. The storage device 1200 may determine the data unit based on the second data unit handle DUH2 and the data group information. The data group information includes the first data group DG1, so the storage device 1200 may determine the data unit DU12 referenced by the second data unit handle DUH2 in the first data group DG1. The data group information includes the second data group DG2, so the storage device 1200 may determine the data unit DU21 referenced by the second data unit handle DUH2 in the second data group DG2. The storage device 1200 may store data in the determined data units DU12 and DU21.

In operation S250, the storage device 1200 may store data in the first area A1. For example, it is assumed that the date group information of the directive value DSPEC may include the first data group DG1 and the second data group DG2. The type information indicates the first type T1, so the storage device 1200 may determine, as the first data unit handle DUH1, the data unit handle DUH in which to store data. The storage device 1200 may determine the data unit based on the first data unit handle DUH1 and the data group information. The data group information includes the first data group DG1, so the storage device 1200 may determine the data unit DU11 referenced by the first data unit handle DUH1 in the first data group DG1. The data group information includes the second data group DG2, so the storage device 1200 may determine the data unit DU22 referenced by the first data unit handle DUH1 in the second data group DG2. The storage device 1200 may store data in the determined data units DU11 and DU22.

For example, when the adaptive data placement feature is disabled, data may be stored in the second area A2. Additionally, without intervention from the host device 1100, the storage device 1200 may determine a data unit in which data is to be stored.

As described above, the storage device 1200 may perform the adaptive data placement operation. The storage device 1200 may determine the data unit in which to store data under the control by the host device 1100. Accordingly, the storage device 1200 with improved reliability may be provided.

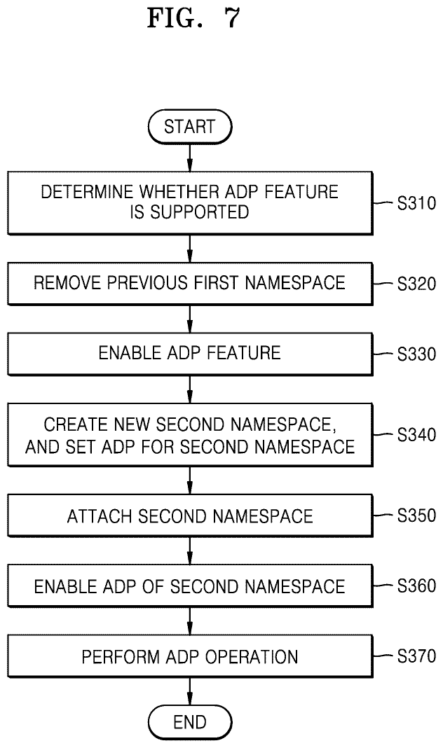

FIG. 7 is a flowchart showing an example of an operation method of the storage system 1000 of FIG. 1.

Referring to FIGS. 1 and 7, the storage system 1000 may perform the adaptive data placement operation. The storage system 1000 may enable the adaptive data placement feature and set a configuration of the adaptive data placement feature to perform the adaptive data placement operation.

In an implementation, the host device 1100 may support or manage the adaptive data placement feature for the storage device 1200. The host device 1100 may enable or disable the adaptive data placement feature of the storage device 1200. When the adaptive data placement feature is enabled, the host device 1100 and the storage device 1200 may perform the adaptive data placement operation.

In an implementation, the operations S310 to S360 may be performed at the initialization or reset of the storage system 1000. Alternatively, the operations S310 to S360 may be performed at the explicit request of the host device 1100. For example, the storage system 1000 may perform operations S310 to S360, in response to power-up or initialization initiation information.

In operation S310, the storage system 1000 may determine whether the storage system 1000 supports the adaptive data placement feature. In an implementation, the host device 1100 may determine whether the storage device 1200 supports the adaptive data placement feature. The host device 1100 may not perform the following operations when the storage device 1200 does not support the adaptive data placement feature. In an implementation, the host device 1100 may determine whether the storage device 1200 supports the adaptive data placement feature via an identify command.

In operation S320, the storage system 1000 may remove a previous first namespace. The host device 1100 may be required to create a new namespace in order to utilize the adaptive data placement feature. Accordingly, the host device 1100 may remove the first namespace of the storage device 1200. In an implementation, the host device 1100 may remove the first namespace of the storage device 1200 via a namespace management command and a namespace attachment command.

In operation S330, the storage system 1000 may enable the adaptive data placement feature. For example, the host device 1100 may enable the adaptive data placement feature of the storage device 1200. The host device 1100 may enable the adaptive data placement feature of the storage device 1200 via a set-feature command. Additionally, the host device 1100 may determine whether the adaptive data placement feature of the storage device 1200 is enabled via a get log page command or a get feature command.

In operation S340, the storage system 1000 may create a new second namespace and set the configuration of the adaptive data placement feature for the second namespace. For example, the host device 1100 may create the second namespace via the namespace management command. The host device 1100 may set the configuration of the adaptive data placement feature for the second namespace via the namespace management command.

In operation S350, the storage system 1000 may attach the second namespace. For example, the host device 1100 may attach the second namespace of the storage device 1200 via the namespace attachment command.

In operation S360, the storage system 1000 may enable the adaptive data placement operation for the second namespace. For example, the host device 1100 may enable the adaptive data placement operation for the second namespace via a directive send command.

For example, the host device 1100 may create a plurality of namespaces for the storage device 1200. The host device 1100 may set whether the adaptive data placement operation is enabled for each of the plurality of namespaces. The host device 1100 may create the second namespace and a third namespace for the storage device 1200. The host device 1100 may enable the adaptive data placement operation for the second namespace. The host device 1100 may disable the adaptive data placement feature for the third namespace.

The host device 1100 may perform input/output operations after the initialization operation for the storage device 1200 is completed. The host device 1100 may transmit the read command or the write command to the storage device 1200.

In operation S370, the storage system 1000 may perform the adaptive data placement operation. For example, the host device 1100 may transmit, to the storage device 1200, the write command that includes the type information about the type of memory in which the write data is to be stored. The host device 1100 may transmit the type information or the data group information to the storage device 1200 through the directive value DSPEC included in the write command. The storage device 1200 may determine whether the adaptive data placement feature of the namespace corresponding to the write command is enabled. The storage device 1200 may store write data based on the directive value DSPEC included in the write command when the adaptive data placement feature is enabled. The storage device 1200 may determine an area in which write data is to be stored based on the type information received from the host device 1100. The storage device 1200 may store write data in an area corresponding to the directive value DSPEC.

As described above, the host device 1100 may transmit the write command including the directive value DSPEC to the storage device 1200. The storage device 1200 may receive data corresponding to the write command, in response to the write command, and may store data in one area which corresponds to the directive value DSPEC, of the first area A1 and the second area A2, in response to the enabled adaptive data placement feature. Accordingly, the storage system 1000 with improved reliability may be provided.

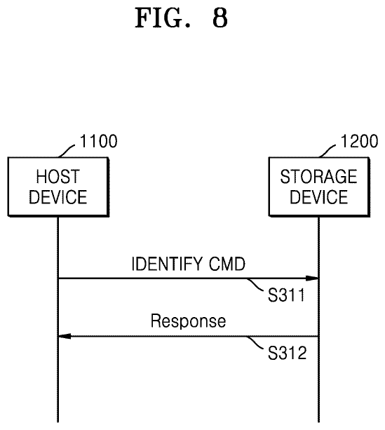

FIG. 8 is a flowchart showing operation S310 of FIG. 7 in more detail.

Referring to FIGS. 1, 7, and 8, the host device 1100 may determine whether the storage device 1200 supports the adaptive data placement feature. In an implementation, the host device 1100 may determine whether the storage device 1200 supports the adaptive data placement feature via the identify command. Operation S310 of FIG. 7 may include operations S311 and S312.

In operation S311, the host device 1100 may transmit the identify command to the storage device 1200. In operation S312, the storage device 1200 may transmit a response corresponding to the identify command to the host device 1100. For example, the storage device 1200 may transmit an identification controller data structure to the host device 1100. The identification controller data structure may include an adaptive data placement support field. When the adaptive data placement support field indicates a first value (e.g., “0”), the storage device 1200 may indicate that the storage device 1200 does not support the adaptive data placement feature. When the adaptive data placement support field indicates a second value (e.g., “1”), the storage device 1200 may indicate that the storage device 1200 supports the adaptive data placement feature. For example, the storage device 1200 may transmit the completion entry corresponding to the identify command to the host device 1100.

As described above, the host device 1100 may transmit the identify command to the storage device 1200. The storage device 1200 may provide information on whether the adaptive data placement is supported to the host device 1100, in response to the identify command.

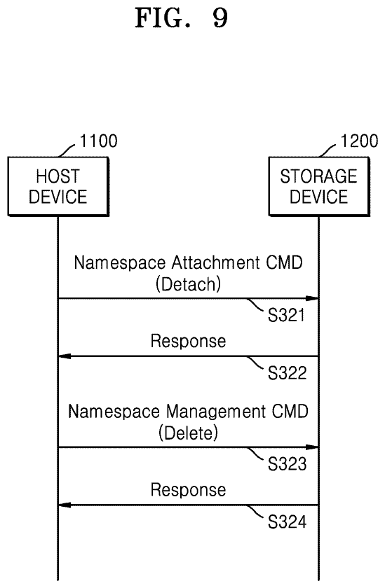

FIG. 9 is a flowchart showing operation S320 of FIG. 7 in more detail.

Referring to FIGS. 1, 7, and 9, the storage system 1000 may remove the previous first namespace. The storage system 1000 may remove the first namespace through the namespace attachment command and the namespace management command. Operation S320 of FIG. 7 may include operations S321 to S324.

In operation S321, the host device 1100 may transmit the namespace attachment command to the storage device 1200. The namespace attachment command may include a selection field. For example, the selection field may indicate controller detach. The storage device 1200 may receive the namespace attachment command. The storage device 1200 may perform a namespace detach operation in response to the namespace attachment command.

In operation S322, the storage device 1200 may transmit a response corresponding to the namespace attachment command to the host device 1100. For example, the storage device 1200 may transmit the completion entry corresponding to the namespace attachment command to the host device 1100.

In operation S323, the host device 1100 may transmit the namespace management command to the storage device 1200. The namespace management command may include the selection field. For example, the selection field may indicate deletion. The storage device 1200 may receive the namespace management command. The storage device 1200 may perform a namespace deletion operation in response to the namespace management command.

In operation S324, the storage device 1200 may transmit a response corresponding to the namespace management command to the host device 1100. For example, the storage device 1200 may transmit the completion entry corresponding to the namespace management command to the host device 1100.

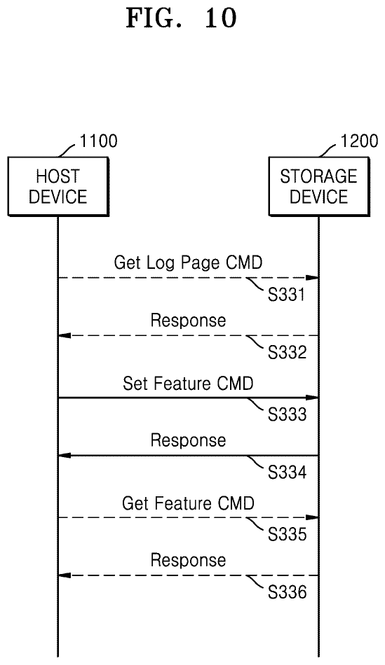

FIG. 10 is a flowchart showing operation S330 of FIG. 7 in more detail.

Referring to FIGS. 1, 7, and 10, the storage system 1000 may enable the adaptive data placement feature. The storage system 1000 may enable the adaptive data placement feature of the storage device 1200 through the set-feature command. Operation S330 of FIG. 7 may include operations S333 and S334. Alternatively, operation S330 of FIG. 7 may include operations S331 to S336. Any one of operations S331, S332, S335, and S336 may be omitted.

In operation S331, the host device 1100 may transmit a get log page command to the storage device 1200. For example, the get log page command may include a log page identifier that indicates the adaptive data placement. The storage device 1200 may receive the get log page command.

In operation S332, the storage device 1200 may transmit a response corresponding to the get log page command to the host device 1100. The storage device 1200 may transmit a log page related to the adaptive data placement to the host device 1100, in response to the get log page command. For example, the log page related to the adaptive data placement may include information about setting of the adaptive data placement.

For example, through the log page, the storage device 1200 may provide information about the type of memory that may be provided by the storage device 1200, information about the number of the types of memory that may be supported, information about the number of data unit handles, information about the number of data groups, and the like.

In operation S333, the host device 1100 may transmit the set-feature command to the storage device 1200. For example, the set-feature command may include a feature identifier. The feature identifier may indicate the adaptive data placement. The set-feature command may include an adaptive data placement enablement field. The adaptive data placement enablement field may indicate enablement. The storage device 1200 may receive the set-feature command. The storage device 1200 may enable the adaptive data placement feature in response to the set-feature command.

In operation S334, the storage device 1200 may transmit a response corresponding to the set-feature command to the host device 1100. The storage device 1200 may transmit the completion entry corresponding to the set-feature command to the host device 1100.

In operation S335, the host device 1100 may transmit a get-feature command to the storage device 1200. For example, the get-feature command may include the feature identifier. The feature identifier may indicate the adaptive data placement. The storage device 1200 may receive the get-feature command.

In operation S336, the storage device 1200 may transmit a response corresponding to the get-feature command to the host device 1100. For example, the storage device 1200 may transmit the completion entry corresponding to the get-feature command to the host device 1100.

As described above, the host device 1100 may transmit the set-feature command to the storage device 1200 in connection with the adaptive data placement feature. The storage device 1200 may enable or disable the adaptive data placement feature in response to the set-feature command.

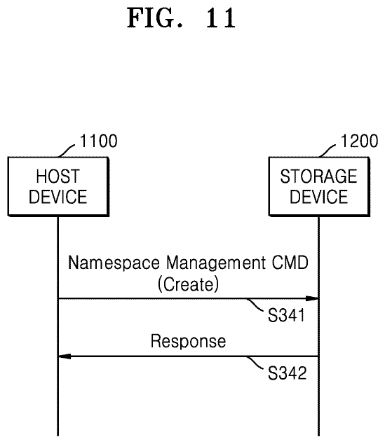

FIG. 11 is a flowchart showing operation S340 of FIG. 7 in more detail.

Referring to FIGS. 1, 7, and 11, the storage system 1000 may create a new second namespace and set a configuration of the adaptive data placement feature for the second namespace. In an implementation, the storage system 1000 may create the namespace and set the configuration of the adaptive data placement feature via the namespace management command. Operation S340 of FIG. 7 may include operations S341 and S342.

In operation S341, the host device 1100 may transmit the namespace management command to the storage device 1200. The namespace management command may include the selection field. For example, the selection field may indicate creation. In an implementation, the namespace management command may include a list of memory types. For example, the list of memory types may include the first type T1 and the second type T2.

The storage device 1200 may receive the namespace management command. The storage device 1200 may perform a namespace creation operation in response to the namespace management command. The storage device 1200 may manage the data unit handles based on the list of memory types included in the namespace management command. The storage device 1200 may map (or assign) the data unit handles to the memory type included in the list of memory types. For example, the storage device 1200 may map the first data unit handle DUH1 to the first type T1 and map the second data unit handle DUH2 to the second type T2.

In operation S342, the storage device 1200 may transmit a response corresponding to the namespace management command to the host device 1100. For example, the storage device 1200 may transmit the completion entry corresponding to the namespace management command to the host device 1100.

As described above, the host device 1100 may transmit the namespace management command. The storage device 1200 may create the namespace and map the list of memory types and the data unit handles in response to the namespace management command that includes the selection field indicating a create operation.

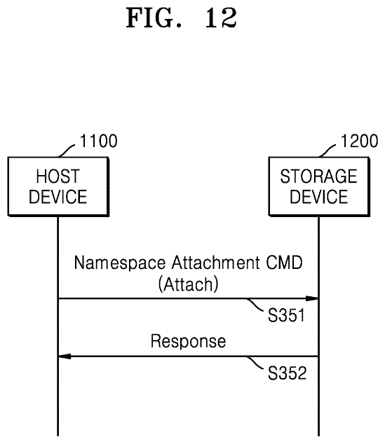

FIG. 12 is a flowchart showing operation S350 of FIG. 7 in more detail.

Referring to FIGS. 1, 7, and 12, the storage system 1000 may attach the namespace. In an implementation, the storage system 1000 may attach the namespace via the namespace attachment command. Operation S350 of FIG. 7 may include operations S351 and S352.

In operation S351, the host device 1100 may transmit the namespace attachment command to the storage device 1200. The namespace attachment command may include the selection field. For example, the selection field may indicate controller attach. The storage device 1200 may receive the namespace attachment command. The storage device 1200 may perform a namespace attachment operation in response to the namespace attachment command.

In operation S352, the storage device 1200 may transmit a response corresponding to the namespace attachment command to the host device 1100. For example, the storage device 1200 may transmit the completion entry corresponding to the namespace attachment command to the host device 1100.

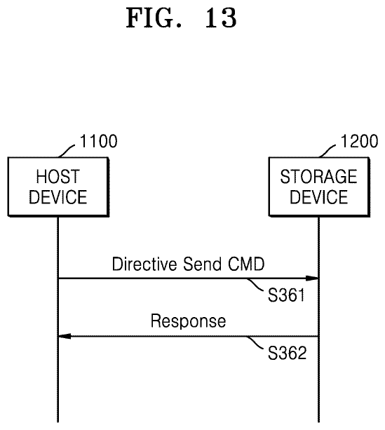

FIG. 13 is a flowchart showing operation S360 of FIG. 7 in more detail.

Referring to FIGS. 1, 7, and 13, the storage system 1000 may enable the adaptive data placement in the namespace. In an implementation, the storage system 1000 may enable the adaptive data placement in the namespace via a directive send command. Operation S360 of FIG. 7 may include operations S361 and S362.

In operation S361, the host device 1100 may transmit the directive send command to the storage device 1200. The directive send command may include a directive type field. For example, the directive type may indicate the memory type. The directive send command may include a directive operation DOPER field. For example, the directive operation field may indicate enablement of the adaptive data placement. The storage device 1200 may receive the directive send command. The storage device 1200 may enable the adaptive data placement in the namespace corresponding to the directive send command, in response to the directive send command.

In operation S362, the storage device 1200 may transmit a response corresponding to the directive send command to the host device 1100. For example, the storage device 1200 may transmit the completion entry corresponding to the directive send command to the host device 1100.

As described above, the host device 1100 may transmit the directive send command to the storage device 1200. The storage device 1200 may enable or disable the adaptive data placement for the namespace in response to the directive send command.

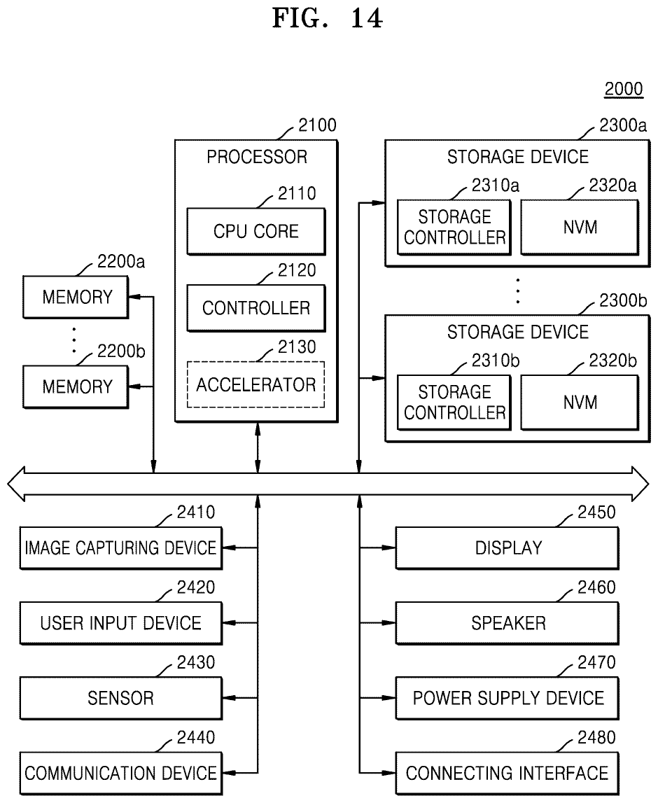

FIG. 14 is a diagram illustrating a system according to some implementations.

Referring to FIG. 14, a system 2000 may include a main processor 2100, memories 2200a and 2200b, and storage devices 2300a and 2300b, and may additionally include one or more of an image capturing device 2410, a user input device 2420, a sensor 2430, a communication device 2440, a display 2450, a speaker 2460, a power supply device 2470, and a connecting interface 2480.

The main processor 2100 may control overall operations of the system 2000, more specifically, the operations of other components that constitute the system 2000. The main processor 2100 may be implemented as a general-purpose processor, a dedicated processor, or an application processor.

The main processor 2100 may include one or more central processing unit (CPU) cores 2110 and may further include a controller 2120 for controlling the memories 2200a and 2200b and/or the storage devices 2300a and 2300b. Depending on implementations, the main processor 2100 may further include an accelerator 2130, which is a dedicated circuit for high-speed data operations such as artificial intelligence (AI) data operations. The accelerator 2130 may include a graphics processing unit (GPU), a neural processing unit (NPU), and/or a data processing unit (DPU), and may be implemented as a separate chip that is physically independent from other components of the main processor 2100.

The memories 2200a and 2200b may be used as a main memory device of the system 2000 and may include a volatile memory such as SRAM and/or DRAM, but may also include a non-volatile memory such as flash memory, FRAM, PRAM, and/or RRAM. The memories 2200a and 2200b may also be implemented within the same package as the main processor 2100.

The storage devices 2300a and 2300b may function as a non-volatile storage device that stores data regardless of whether power is supplied thereto, and may have a relatively large storage capacity compared to the memories 2200a and 2200b. The storage devices 2300a and 2300b may include storage controllers 2310a and 2310b and non-volatile memories (NVM) 2320a and 2320b in which data is stored under the control by the storage controllers 2310a and 2310b. The non-volatile memories 2320a and 2320b may include flash memory having a 2-dimensional (2D) structure or a 3-dimensional (3D) vertical NAND (VNAND) structure, but may also include other types of non-volatile memory such as PRAM and/or RRAM.

The storage devices 2300a and 2300b may be physically separated from the main processor 2100 and included in the system 2000, or may be implemented within the same package as the main processor 2100. In addition, the storage devices 2300a and 2300b may have a form such as a solid state device or a memory card, and may be detachably connected to other components of the system 2000 through an interface such as the connecting interface 2480 to be described below. The storage devices 2300a and 2300b may include devices to which standard specifications such as UFS, eMMC, or NVMe are applied, but are not necessarily limited thereto.

The image capturing device 2410 may capture still images or video, and may include a camera, a camcorder, and/or a webcam.

The user input device 2420 may receive various types of data input from a user of the system 2000, and may include a touch pad, a keypad, a keyboard, a mouse, and/or a microphone.

The sensor 2430 may detect various types of physical quantities that may be obtained from outside the system 2000, and may convert the detected physical quantities into electrical signals. The sensor 2430 may include a temperature sensor, a pressure sensor, a light sensor, a position sensor, an acceleration sensor, a biosensor, and/or a gyroscope sensor.

The communication device 2440 may perform transmission and reception of signals with other devices outside of the system 2000 according to various communication protocols. The communication device 2440 may be implemented including an antenna, a transceiver, and/or a modem.

The display 2450 and speaker 2460 may function as output devices that output visual information and auditory information, respectively, to the user of the system 2000.

The power supply device 2470 may appropriately convert power supplied from a battery (not shown) built into the system 2000 and/or an external power source and supply the power to each component of the system 2000.

The connecting interface 2480 may provide a connection between the system 2000 and an external device that is connected to the system 2000 and may transmit data to and from the system 2000. The connecting interface 2480 may be implemented in various interface methods such as ATA, SATA, e-SATA, SCSI, SAS, PCI, PCIe, NVMe, IEEE 1394, USB, SD card, MMC, eMMC, UFS, eUFS, CF card interface, etc.

In an implementation, the main processor 2100 may include the host device 1100, or the host controller 1110 of the host device 1100 described with reference to FIGS. 1 to 13. The storage devices 2300a and 2300b may include the storage device 1200 described with reference to FIGS. 1 to 13. The system 2000 may perform the adaptive data placement operation based on the methods described with reference to FIGS. 1 to 13.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A storage device comprising:
a non-volatile memory device comprising a first area and a second area; and
a storage controller configured to communicate with an external host device, wherein the storage controller is configured to:
receive, from the external host device, a write command comprising a directive value;
receive data corresponding to the write command; and
in response to an adaptive data placement feature being enabled, store the data in one of the first area or the second area that corresponds to the directive value,
wherein the first area comprises memory cells configured to store n-bits per cell, and the second area comprises memory cells configured to store m-bits per cell, wherein n is a positive integer, and m is a positive integer greater than n.

2. The storage device of claim 1, wherein the directive value comprises (i) type information that indicates one of the first area or the second area, and (ii) data group information.

3. The storage device of claim 1, wherein the storage controller is configured to, in response to an identify command, provide information indicative of the adaptive data placement feature being supported to the external host device.

4. The storage device of claim 1, wherein the storage controller is configured to, in response to a set-feature command, enable or disable the adaptive data placement feature.

5. The storage device of claim 1, wherein the storage controller is configured to, in response to a namespace management command that comprises a selection field indicating a creating operation, create a namespace and map a list of memory types to data unit handles.

6. The storage device of claim 1, wherein the storage controller is configured to, in response to a directive send command, enable or disable the adaptive data placement feature for a namespace.

7. The storage device of claim 1, wherein the storage controller is configured to, in response to a data move command received from the external host device, move data stored in the first area to the second area.

8. A method of operating a storage system comprising a host device and a storage device, the method comprising:
transmitting, using the host device and to the storage device, a write command that comprises a directive value;
receiving, using the storage device and in response to the write command, data corresponding to the write command; and
storing, using the storage device and in response to an adaptive data placement feature being enabled, the data in one of a first area or a second area that corresponds to the directive value,
wherein the storage device comprises a non-volatile memory device that comprises the first area and the second area, and
wherein the first area comprises memory cells configured to store n-bits per cell, and the second area comprises memory cells configured to store m-bits per cell, wherein n is a positive integer, and m is a positive integer greater than n.

9. The method of claim 8, comprising:
transmitting, using the host device, an identify command to the storage device; and
providing, using the storage device in response to the identify command, information indicative of the adaptive data placement feature being supported to the host device.

10. The method of claim 8, comprising: removing a first namespace using the host device.

11. The method of claim 10, wherein removing the first namespace comprises:
transmitting, using the host device and to the storage device, a namespace attachment command, the namespace attachment command comprising a selection field that indicates a detachment operation; and
transmitting, using the host device and to the storage device, a namespace management command, the namespace management command comprising a selection field that indicates a deletion operation.

12. The method of claim 8, comprising:
transmitting, using the host device and to the storage device, a set-feature command,
wherein the set-feature command comprises (i) a feature identifier that indicates the adaptive data placement feature; and (ii) an enablement field of the adaptive data placement feature that indicates an enablement operation.

13. The method of claim 12, comprising:
transmitting, using the host device and to the storage device, a get log page command, the get log page command comprising a log page identifier that indicates the adaptive data placement feature.

14. The method of claim 8, comprising:
transmitting, using the host device and to the storage device, a namespace management command, the namespace management command comprising a list of memory types and a selection field that indicates a creation operation.

15. The method of claim 8, comprising:
transmitting, using the host device and to the storage device, a namespace attachment command, the namespace attachment command comprising a selection field that indicates an attachment operation.

16. The method of claim 8, comprising:
transmitting, using the host device and to the storage device, a directive send command, wherein the directive send command comprises (i) a directive type field that indicates memory types, and (ii) a directive operation field that indicates enablement of the adaptive data placement feature.

17. A storage system comprising:
a storage device comprising a first area and a second area; and
a host device configured to control the storage device,
wherein the host device is configured to enable an adaptive data placement feature of the storage device and transmit a write command to the storage device, wherein the write command comprises a directive value that indicates type information indicative of a type of an area where data is to be stored,
wherein the storage device is configured to, in response to the adaptive data placement feature being enabled and in response to the write command, store the data in one of the first area or the second area that corresponds to the directive value, and
wherein the first area comprises memory cells configured to store n-bits per cell, and the second area comprises memory cells configured to store m-bits per cell, wherein n is a positive integer, and m is a positive integer greater than n.

18. The storage system of claim 17, wherein the directive value comprises (i) type information that indicates one of the first area or the second area, and (ii) data group information.

19. The storage system of claim 17,
wherein the host device is configured to transmit a directive send command to the storage device,
wherein the storage device is configured to, in response to the directive send command, enable the adaptive data placement feature, and
wherein the directive send command comprises (i) a directive type field that indicates memory types, and (ii) a directive operation field that indicates enablement of the adaptive data placement feature.

20. The storage system of claim 17, wherein the host device is configured to transmit a move command to the storage device to move the data stored in the first area to the second area.
